(19) United States
(12) Patent Application Publication
(10) Pub. No.: US 2013/0276654 A1
(43) Pub. Date: Oct. 24, 2013

(54) CONVEYOR BELT CLEANING METHOD AND APPARATUS

(71) Applicant: Jeffrey Belbeck, Mississauga (CA)

(72) Inventor: Jeffrey Belbeck, Mississauga (CA)

(21) Appl. No.: 13/454,494

(22) Filed: Apr. 24, 2012

(51) Int. Cl. B41F 35/00

(52) U.S. Cl. 101/425

(57) ABSTRACT

A method and apparatus for cleaning a continuous conveyor belt. The apparatus has a dispenser for dispensing cleaning fabric so that a length of it is positioned against a length of the belt. The length of belt is driven downstream direction and dispenser is operated to drive the length of cleaning fabric in an upstream direction and recharge it. Cleaning fluid is applied to the fabric at an upstream end region. The belt is rubbed and washed the upstream end region. The belt is dried at a downstream end region where it encounters dry cleaning.

### FIELD OF THE INVENTION

This invention relates to a method and apparatus for cleaning a conveyor belt and is particularly applicable to cleaning a conveyor belt for use in conveying sheet media such as paper through an ink jet printer.

### BACKGROUND OF THE INVENTION

It is desirable when printing on paper or other sheet materials, whether in the form of cut sheets or roll/web sheet media, to have a printing environment which is as clean and contaminant-free as possible. This is particularly so in the case of inkjet printers where inkjet nozzles may become partially or fully blocked, in spite of the regular use of conventional maintenance equipment and techniques to keep the nozzles functioning efficiently during and between printing cycles. One source of nozzle blockage is dried ink which may accumulate on a print head from failure effectively to apply the conventional printhead maintenance procedures or through some fault of the maintenance equipment. Another source of dried ink particles is spillage onto transport equipment operated to transport sheet media to and from the print head.

A transport equipment of particular interest for transporting cut sheets to and from an inkjet print station is a belt conveyor such as the belt conveyor system disclosed in U.S. patent application Ser. No. 13/368,280 (Multiple print head printing apparatus and method of operation) filed Feb. 7, 2012, the contents of which are hereby incorporated by reference in their entirety and made part of the present United States patent application for all purposes. The aforesaid application describes a printing apparatus having a series of inkjet print heads spaced from one another in a transport direction. A continuous belt driven around a roller system is used to feed sheet media successively to the print heads so that a partial image printed by one print head is overprinted at a subsequent print head with registration of the partial images. A sheet medium is caused to become electrostatically tacked to the belt by passing the sheet past a charging device. Movement of the belt is tracked by a tracking sub-system and operation of the print heads is coordinated with the tracked belt movement to achieve precise registration of the partial images. The nature of this transport system means that every part of the continuous belt tracks under the print heads during the printing process.

It is important that the nozzles of the inkjet printhead nozzles are kept free from particulate matter. Such particulate matter can cause nozzles to become fully or partially blocked. Either occurrence will cause deterioration in print quality arising from less than optimal volume and placement of jetted ink droplets. One potential source of contamination in the electrostatic paper transport method is the conveyor belt becoming contaminated by ink. Among the reasons for ink getting on the belt are:
printing “off page” when doing “full bleed” (edge to edge) printing;
“inter-page spitting” (firing of the ink jet nozzles in the gaps between pages) to prevent dehydration of the nozzles;
ink mist (very small drops of ink that become airborne and do not land on the paper);
paper jams (ink is printed on the belt if expected paper is not present);
printhead malfunction causing spillage of ink onto the belt.

Simple wiping of the belt with a cloth is not sufficient to remove ink from the belt if the ink used is quick to dry. Application of water to the fabric, and wiping the belt with the moist fabric, is necessary to remove the ink from the belt. Loosely attached particulate ink residue may disrupt ink flow and degrade print quality if allowed to redeposit onto the nozzle area of the inkjet print head. In addition, any of the belt transport, drive rolls and optical sensors may also suffer damage from contamination by particulate matter including detached dry ink residue. It is desirable to limit the amount of such ink residue near inkjet nozzles.

### SUMMARY OF THE INVENTION

According to one aspect of the invention, there is provided a method for cleaning a continuous conveyor belt comprising dispensing cleaning fabric so that a length thereof is positioned against a length of the continuous belt, driving the belt so that the length thereof moves in a downstream direction, dispensing the cleaning fabric so that the length thereof moves in an upstream direction with the length of cleaning fabric being recharged by the dispensing, and wetting the length of cleaning fabric at an upstream end region thereof with a cleaning fluid to apply cleaning fluid to the belt.

According to another aspect of the invention, there is provided Apparatus for cleaning a continuous conveyor belt, comprising a dispenser for dispensing cleaning fabric so that a length thereof is positioned against a length of a continuous belt, a first drive to the belt for driving the length of belt in a downstream direction, a second drive to the dispenser to drive and recharge the length of cleaning fabric in an upstream direction, and a wetting station for wetting the length of cleaning fabric at an upstream end region thereof with a cleaning fluid whereby to apply cleaning fluid to the belt.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a side view of an inkjet printer sheet feed arrangement according to an embodiment of the invention.

FIG. 2 is a plan view of cleaning apparatus for cleaning the belt of the sheet feed transport arrangement of FIG. 1.

FIG. 3 is a cross-sectional view on the line A-A of FIG. 2.

FIG. 4 is a perspective view of the cleaning apparatus of FIG. 2 but detached from a belt to be cleaned and not showing cleaning fabric to be used in cleaning the belt.

FIG. 5 is a schematic view of a control system for the cleaning apparatus of FIG. 2 according to an embodiment of the invention.

### DETAILED DESCRIPTION OF THE INVENTION INCLUDING THE PRESENTLY PREFERRED EMBODIMENTS

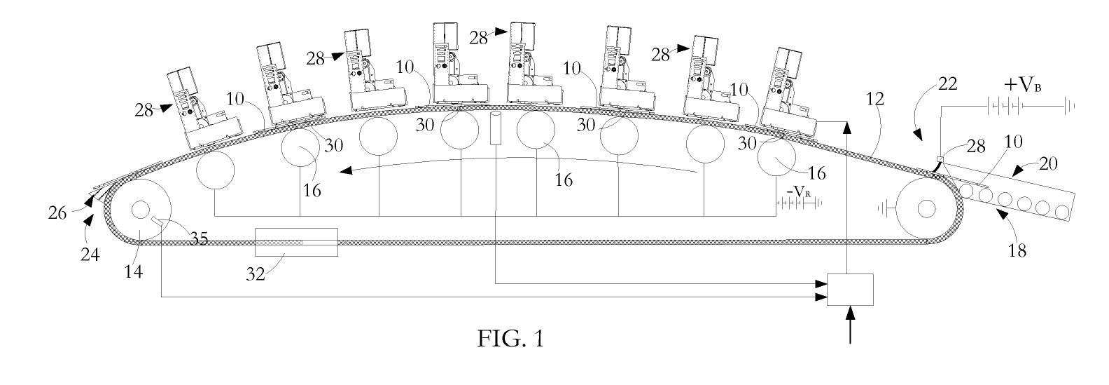

Referring detail to FIG. 1, there is shown a paper transport equipment for transporting cut paper sheets 10 on a continuous belt 12, the belt being driven by a drive roller 14 around a series of idler rollers 16. At an input zone, shown generally as 18, there is a sheet alignment sub-system 20 and a charge transfer sub-system 22. At an output zone shown generally as 24, is a paper sheet stripper arrangement 26. Each of the idler rollers 16 is located adjacent a corresponding inkjet print engine 28 each print engine 28 containing an inkjet print head 30 and mechanical, electrical and fluidic hardware needed to position and operate the print head. The inkjet print engine array comprises eight print engines arranged in two staggered banks of four print engines. As shown in this side view, the print engines of each bank are arranged in a wide diameter arc with each print engine facing the belt where the belt 12 passes over an associated idler roller 16. On the face of each print head 30 are nozzles having exit openings that are spaced from the upper surface of the belt by ½ to 1 millimetre. By tensioning the continuous belt 12 over the arcuate arrangement of rollers 16, the print head to belt spacing is maintained at a comparatively unvarying distance. The belt 12 is made of Mylar®, an electrical insulator having a high dielectric strength which is important because during a printing operation, cut paper sheets 10 are maintained in position on the belt 12 by being electrostatically tacked to the belt. Charge is imparted to the cut paper sheets 12 as they are launched onto the belt by the charge transfer sub-system 22. In the course of a printing operation, the cut sheets 10 are conveyed from right to left as shown in FIG. 1 and as they pass under the array of inkjet printheads 30, the printheads are operated to print partial images on the transported sheets. By ensuring accurate positioning and tracking of the electrostatically tacked sheets 10, accurate high resolution composite images can be obtained consisting of superimposed partial images from successive printheads 30.

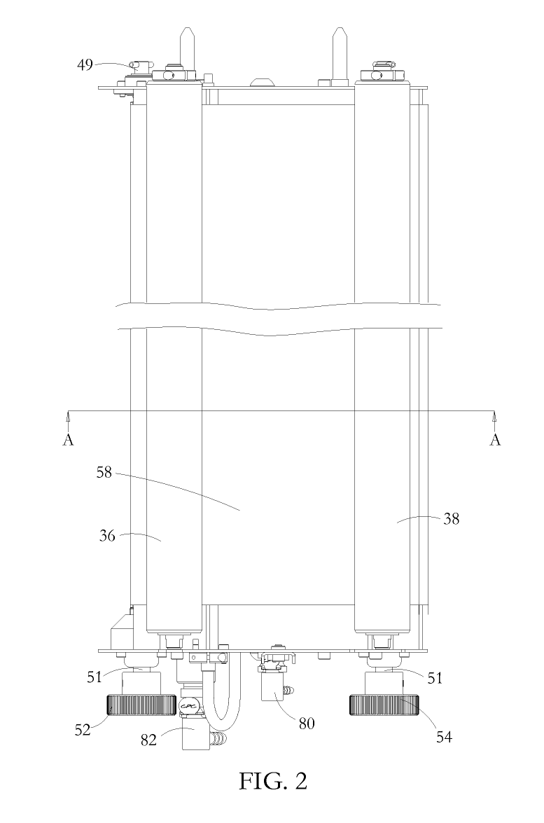

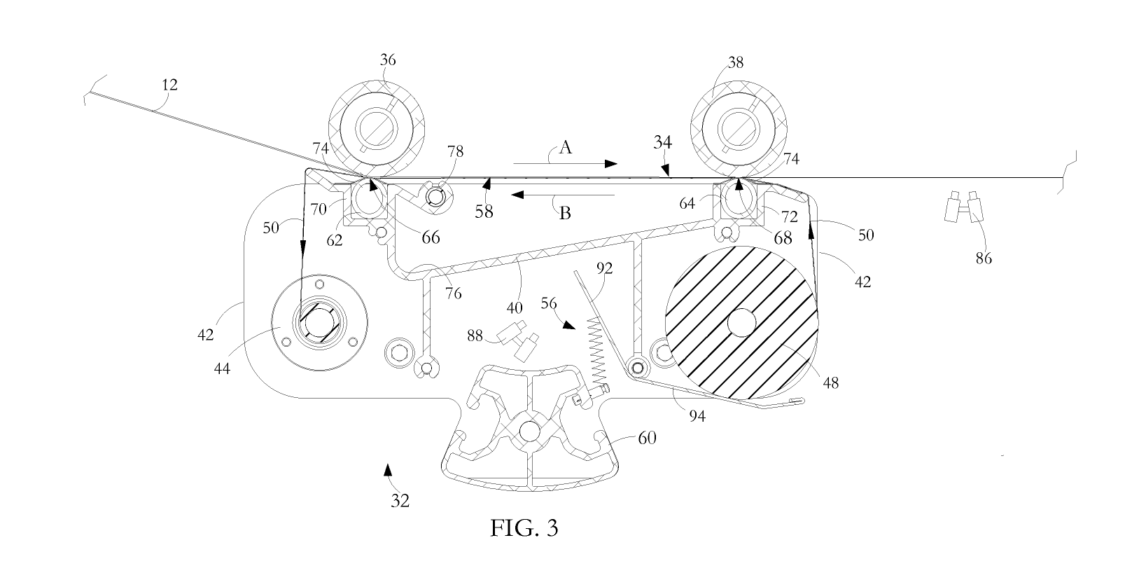

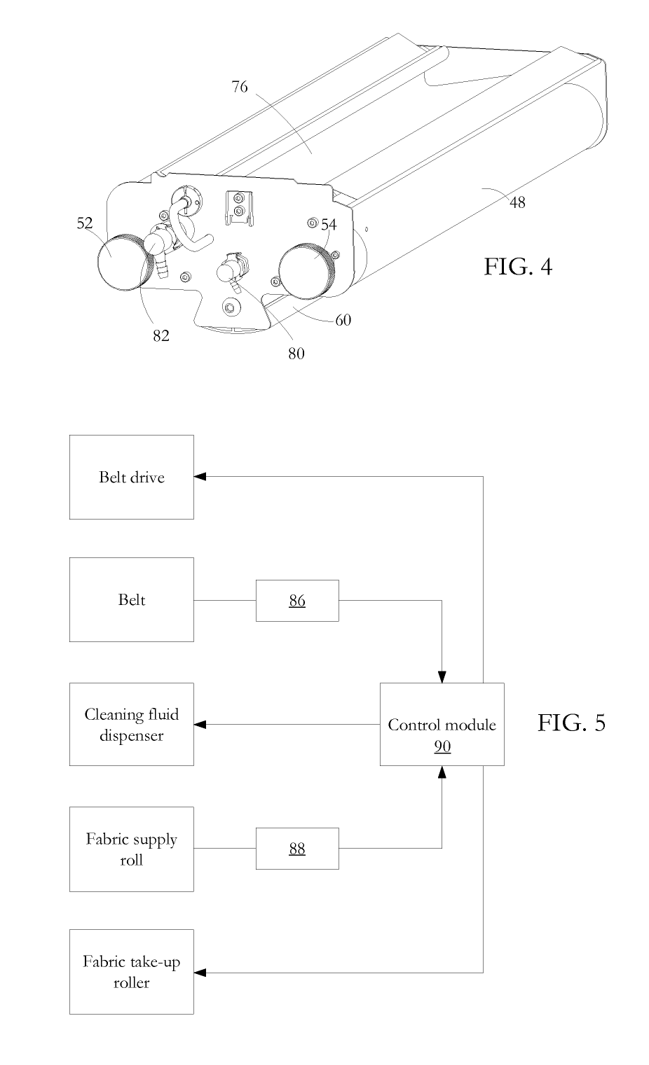

Shown schematically in FIG. 1 is a belt cleaning station 32 at which the belt 12 is cleaned to ensure that there is no build-up of foreign materials, primarily ink from spillage or from misdirected or mistimed inkjets. Belt cleaning apparatus at the cleaning station 32 is shown in plan view in FIG. 2, in cross-section in FIG. 3, and in perspective view in FIG. 4. In FIG. 3, the belt cleaning apparatus 32 is shown in position adjacent a part 34 of a return span of the continuous belt 12. The belt is driven in a direction A to pass over successive idler rollers 36, 38 being one pair of the idler rollers 16 which together define the path of the belt 12. The upper span of the belt 12 for conveying paper sheets 10 is shown only in FIG. 1.

The cleaning station apparatus includes a support structure consisting of a frame 40 and endplates 42. The structure supports a cleaning fabric take-up roller 44 and an associated supply roller 48 for dispensing cleaning fabric 50 having a width equal to substantially the width of the belt 12. In one embodiment, the belt has a width of 508 millimetres and the fabric has a width of 495 millimetres. The take-up roller 44 is driven by a drive shaft 49 at the back side of the cleaning unit. The drive shaft is driven by a motor mounted on the back plate of the transport equipment (not shown), with a coupling on the motor shaft automatically engaging with the take-up roller drive shaft 49 when the belt cleaning apparatus is mounted on the transport equipment. At the front of the belt cleaning unit, knobs 52 and 54 are attached to spring loaded cantilever shafts 51 that support the front ends of the supply and take-up rollers 44, 48. Pulling on one or other of the knobs 52, 54 releases the shaft from the corresponding roller to facilitate changing of the fabric rolls. In operation, the take-up roller 44 is driven to drag cleaning fabric 50 to the take-up roller from a supply roll of the fabric mounted at the supply roller 48. As shown in FIG. 3, a tensioning device 56 associated with the supply roller 48 is used to ensure that a length 58 of cleaning fabric extending between the supply roller 48 and the take-up roller 44 is maintained in tension. The rollers 44, 48 are positioned close to the belt 12 so that the length 58 of cleaning fabric extending between them lies adjacent to the belt. For use in cleaning the Mylar belt of ink spills, a non-woven fabric is used, the fabric characterized by being water absorbent and having good strength when wet. A thin fabric of the order of 0.3 millimetres in thickness is used so as to obtain a relatively long total length of fabric from a supply roll of a given diameter. The structure includes a handle 60 to facilitate the cleaning apparatus being removed from the inkjet printer transport apparatus to enable a cleaning fabric supply to be recharged.

In operation, the conveyor belt is driven so that the lower return part of the belt 12 moves in the downstream direction A as illustrated in FIG. 2, while the cleaning fabric 50 paid out from the supply roller 48 moves in an upstream direction B. The length 58 of cleaning fabric extending between the rollers 44, 48 is pressed into engagement with the lower surface of the belt 12 by foam springs 62, 64 at zones 66, 68, which are located on the far side of the belt 12 from the idler rollers 36, 38. The foam springs 62, 64 are essentially pipes of closed cell foam material housed within channel form pockets 70, 72. The pockets 70, 72 and the foam springs 62, 64 extend across the full width of the belt 12 and the cleaning fabric 50. The foam springs 62, 64 are squeezed into the pockets 70, 72 and do not rotate as the belt 12 and cleaning fabric 50 move past them. They act to uniformly press the cleaning fabric 50 against the belt 12 to give good contact, the belt 12 at the zones 66, 68 being supported by the idler rollers 36, 38 and preventing upward movement of the belt 12 at the zones. The foam springs 62, 64 may have the pipe form shown or may be of another suitable cross-sectional shape such as rectangular. Thin (0.08 millimetre) Mylar flaps 74 attached to the frame structure 40 cover the foam springs 62, 64 and prevent the cleaning fabric 50 from dragging the foam springs out of their respective pockets 70,72. More foam spring pressure zones can be implemented if desired, but the limited two zone arrangement shown in this embodiment has value insofar as they leave a considerable length of cleaning fabric 50 exposed to allow excess applied water to drain downwardly into a trough. Moreover, it is desirable that any drag on the belt 12 is minimized and is uniform across the belt; such properties are more easily achieved if the number of pressure zones is limited.

A water supply pipe 78 is mounted on the support structure to extend across the width of the cleaning fabric 50. The pipe is located a short distance downstream of the upstream zone 68. It has apertures in a top wall region and is supplied and drained through respective couplings 80, 82. In use, water is sprayed from the pipe 78 against the underside of the cleaning fabric 50 as the fabric is advanced in the upstream direction, with the amount of water dispensed though the apertures depending on the upstream speed of the dispensed fabric 50 and the downstream speed of the belt 12. Excess water drains into a trough and then exits the apparatus through the coupling 82.

In terms of control for the belt cleaning apparatus, in one control arrangement as shown schematically in FIG. 5, a sensor 86 is used to sense reference marks on the belt 12 and a second sensor 88 is used to monitor the cleaning fabric supply roll. Outputs from the sensors 86, 88 are taken to a control module 90 at which the belt speed and the state of the supply roll are determined. On the basis of the measured belt speed, the control module 90 develops outputs to control the take-up roller drive speed and the rate of dispensing of water though the pipe 78. The supply roller sensor 88 operates by detecting the angle of an indicator plate 92 forming one arm of a spring mounted rocker member having a back tension plate 94 bearing against the cleaning fabric supply roll. A signal from the supply roll sensor 88 is used to calculate the supply roll diameter and to use that information to control the drive to the take-up roller 44 so as to maintain a constant linear speed of the fabric 50. The signal from the supply roller sensor 88 is also used to trigger a visual or audible alarm indicating a need for supply roll replacement or, in a more complex arrangement, automatically to initiate an automatic procedure to exchange a discharged supply roller with a fully charged one. The back tension plate 94 of the rocker member also serves to maintain tension in the length 58 of cleaning fabric extending from the supply roller 48 to the take-up roller 44. In one operating regime, the belt 12 was moved downstream at a speed in the order of 300 mm/s, with the cleaning fabric 50 being moved upstream at a speed in the order of 3 mm/sec., but other belt and fabric speeds and water dispensing rates can be chosen depending on what is shown to be most effective in a particular cleaning set-up and operation.

In a further control arrangement, a camera is used to watch a part of the return span of the belt during a printing process. The belt is illuminated and a reference reflection is determined. Any subsequent change in reflected light level is presumed to indicate the presence of foreign material such as spilled ink on the belt and to trigger a cleaning cycle.

Although the embodiment of the invention illustrated identifies the use of water as the cleaning fluid, it will be realized that water may only be effective for cleaning from the belt a foreign material which is at least partly solvent in water. Other cleaning fluids such as organic fluids may be used to clean non-aqueous materials. In such circumstance, materials for the fluid, the cleaning fabric and the belt which, in combination, are compatible in the sense of one material not causing deterioration or other issues when used with the other materials. For example, it will generally be advisable not to use cleaning fluids which are flammable, toxic, or corrosive.

In operation, water is applied from the pipe 78 to the back of the cleaning fabric 58 at a wetting zone adjacent the pipe. The water soaks through the cleaning fabric 58 and contacts the conveying surface of the Mylar belt 12. The fabric 58 is advanced in the direction of arrow B as the belt 12 moves in the direction of arrow A. The fabric 58 is pressed against the belt 12 by the foam springs 62, 64 adjacent each of the idler rollers 36, 38. At the zone 66 near the idler roller 38, the belt 12 is washed by the water and rubbed by the cleaning fabric 58 to dissolve and remove adhering ink and other washable contaminants and to transfer them to the cleaning fabric 58. As the belt 12 and the fabric 58 advance in opposite directions, ink continues to be removed from the belt 12 between the two belt idler rollers 66, 68, but the fabric 58 starts to dry the belt 12 as the belt approaches the belt idler roller 68.

A belt cleaning cycle can be initiated automatically at certain time intervals when the printer is stopped between printing jobs, or the operator can manually initiate a cleaning cycle if a contaminated belt is observed. The fabric can also be slowly advanced during printing, without applying water or other solvents, to partially remove contaminants.

While the belt cleaning apparatus and method of the invention has been described in relation to a conveyor belt for conveying paper past a bank of inkjet printheads, it will be appreciated that the invention can be implemented for any continuous belt conveyor where there is risk of spillage with spilled materials adhering to the belt conveying surface.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A method for cleaning a continuous conveyor belt comprising dispensing cleaning fabric so that a length thereof is positioned against a length of the continuous belt, driving the belt so that the length thereof moves in a downstream direction, dispensing the cleaning fabric so that the length thereof moves in an upstream direction with the length of cleaning fabric being recharged by the dispensing, and wetting the length of cleaning fabric at an upstream end region thereof with a cleaning fluid to apply cleaning fluid to the belt.

2. A method as claimed in claim 1, wherein the cleaning fabric length over an upstream portion thereof wets and rubs the belt length.

3. A method as claimed in claim 1, wherein the cleaning fabric length over a downstream portion thereof rubs and dries the belt length.

4. A method as claimed in claim 1, further comprising pressing at least a portion of the fabric length against the belt.

5. A method as claimed in claim 1, the belt having an article conveying part and a return part, the method further comprising the length of the belt being part of the belt return part.

6. A method as claimed in claim 1, the length of cleaning fabric mounted on and extending between a fabric payout roll and a fabric take-up roll, and a drive means to drive the fabric from the payout roll to the take-up roll.

7. A method as claimed in claim 1, the cleaning fluid being water.

8. A method as claimed in claim 1, further comprising driving the belt in the downstream direction, and driving the cleaning fabric length over the belt in the upstream direction in one of a continuous movement, movement at intervals, and movement in response to detection of material to be cleaned from the belt.

9. A method as claimed in claim 8, further comprising driving the belt in the downstream direction to convey articles, driving the cleaning fabric length over the belt in the upstream direction, and suspending the application of the cleaning fluid while the belt is conveying articles.

10. A method as claimed in claim 1, wherein a front face of the fabric length is positioned against the belt length, the method further comprising wetting the fabric length at a back face of the fabric length, the fabric length absorbing the cleaning fluid whereby to apply the cleaning fluid at the front face of the fabric length.

11. Apparatus for cleaning a continuous conveyor belt, comprising a dispenser for dispensing cleaning fabric so that a length thereof is positioned against a length of a continuous belt, a first drive to the belt for driving the length of belt in a downstream direction, a second drive to the dispenser to drive and recharge the length of cleaning fabric in an upstream direction, and a wetting station for wetting the length of cleaning fabric at an upstream end region thereof with a cleaning fluid whereby to apply cleaning fluid to the belt.

12. Apparatus as claimed in claim 11, further comprising at least one spring member to press at least a portion of the cleaning fabric length against the belt length.

13. Apparatus as claimed in claim 12, the at least one spring member to press the at least a portion of the cleaning fabric length against the belt length at a position or positions where the belt is supported by belt idler rollers.

14. Apparatus as claimed in claim 12, the apparatus having a first such spring member near an upstream end of the length of cleaning fabric and a second such spring member near a downstream end of the length of cleaning fabric.

15. Apparatus as claimed in claim 11, the belt having an article conveying part and a return part, the length of the belt being part of the belt return part.

16. Apparatus as claimed in claim 11, the length of cleaning fabric mounted on and extending between a cleaning fabric payout roll and a cleaning fabric take-up roll, and a drive means to drive the cleaning fabric from the payout roll to the take-up roll.

17. Apparatus as claimed in claim 11, further comprising a dispenser for dispensing the cleaning fluid.

18. Apparatus as claimed in claim 11, the cleaning fabric extending across substantially the full width of the belt length.

19. Apparatus as claimed in claim 11, further comprising a detector to detect material to be cleaned from the belt, and a control loop to the drive to the cleaning fabric for moving the length of cleaning fabric in response to detection of material to be cleaned on the belt.
